(19) United States
(12) Patent Application Publication
(10) Pub. No.: US 2007/0199198 A1
(43) Pub. Date: Aug. 30, 2007

(54) Bendable cutting device

(76) Inventor: Chih-Ching Hsieh, Taichung Hsien (TW)

Correspondence Address: Chih-Ching HSIEH, 235 Chung - Ho, Box 8-24, Taipei, TW

(21) Appl. No.: 11/796,162

(22) Filed: Apr. 27, 2007

Related U.S. Application Data
(63) Continuation-in-part of application No. 11/060,693, filed on Feb. 18, 2005.

(51) Int. Cl. B26B 13/00

(52) U.S. Cl. 30/232

(57) ABSTRACT

A bendable cutting device comprises a pair of holding portions; a pair of cutting portions; the two cutting portions being pivotally installed to one another; an inner side of each cutting portion having a knife portion; each cutting portion being pivotally installed to one end of a respective one of the holding portions. By moving the two cutting portions closer, the two cutting portions serve to cut one object clamped between the two cutting portions. Each cutting portion has a pivotal recess and each holding portion has a pivotal block; a retainer serves to pivotally install the pivotal block to the pivotal recess so that the holding portion is assembled to the cutting portion. One inner side of the pivotal recess has at least one holes and the pivotal block has a positioning unit corresponding to the holes. The positioning unit is formed by a spring and a steel ball.

The present invention is a continuation in part of U.S. patent application Ser. No. 11/060,693 which is assigned to and invented by the inventor and applicant of the present invention. Thus, the content of U.S. patent application Ser. No. 11/060,693 is incorporated into the present invention as a part of the present invention.

### BACKGROUND OF THE INVENTION

(a) Field of the Invention

The present invention relates to cutting devices, and in particular to a bendable cutting device, in that the angles between the holding portions and the cutting portions are adjusted so that the two holding portions are bent to the same side. When cutting an object, the hand of the user can be placed at the same side so as not be interfered by the object to be cut and the hand of the user will not be hurt. Thereby the cutting operation can be performed easily.

(b) Description of the Prior Art

Referring to FIGS. 13, and 14, a prior art cutting device is illustrated. The cutting device is mainly formed by two holding portions 91. One end of one holding portion 91 is pivotally installed to one end of another holding portion 91 by using a pivotal shaft 92. A front end of each holding portion is a knife portion 93. The user holds the holding portions 91 so as to control the knife portions to move closer to cut an object clamped between the two holding portions 91.

However the prior art structure is simple and can be operated easily. In this prior art, the hands are distributed at two sides of the object to be cut. Thereby when the object is cut, the object will pass through two sides of the hand. Thus it is possible that the hand is hurt by the object. Furthermore, if the object is hard and thus is difficult to be bent, for example, a paper plate or an iron plate, it is possible that the object is hindered so as not to be cut easily. Besides, if one end of the object to be cut has obstacles, the cutting operation cannot be performed successfully. Thereby in operation, the user must make his (or her) pose to match the cutting device or an object to be cut. Thereby the prior art structure is not a practical one.

### SUMMARY OF THE INVENTION

Accordingly, the primary object of the present invention is to provide a bendable cutting device, in that the angles between the holding portions and the cutting portions are adjusted so that the two holding portions are bent to the same side. When cutting an object, the hand of the user can be placed at the same side so as not be interfered by the object to be cut and the hand of the user will not be hurt. Thereby the cutting operation can be performed easily.

To achieve above objects, the present invention provides a bendable cutting device which comprises a pair of holding portions; a pair of cutting portions; the two cutting portions being pivotally installed to one another; an inner side of each cutting portion having a knife portion; each cutting portion being pivotally installed to one end of a respective one of the holding portions; so that the holding portions being rotatable to the cutting portions to the same side, wherein by moving the two cutting portions closer, the two cutting portions serve to cut one object clamped between the two cutting portions. Each cutting portion has a pivotal recess and each holding portion has a pivotal block; a retainer serves to pivotally install the pivotal block to the pivotal recess so that the holding portion is assembled to the cutting portion. One inner side of the pivotal recess has at least one holes and the pivotal block has a positioning unit corresponding to the holes. The positioning unit is formed by a spring and a steel ball.

The various objects and advantages of the present invention will be more readily understood from the following detailed description when read in conjunction with the appended drawing.

### BRIEF DESCRIPTION OF THE DRAWINGS

FIG. 1 is an exploded perspective view of the bendable cutting device of the present invention.

FIG. 2 is a partial perspective view of the bendable cutting device of the present invention.

FIG. 3 is a partial perspective view showing that the present invention is in a bending state.

FIG. 4 is a perspective view showing that the present invention is in a bending state.

FIG. 5 is a perspective view showing the operation of the present invention.

FIG. 6 is an exploded perspective view of the second embodiment of the present invention.

FIG. 7 is a partial perspective view of the second embodiment of the present invention.

FIG. 8 is a partial perspective view about the second embodiment of the present invention, where the present invention is at a bending state.

FIG. 9 is a perspective view of second embodiment, where the present invention is at a bending state.

FIG. 10 is a perspective view showing the operation of the second embodiment of the present invention.

FIG. 11 is a partial perspective view of the third embodiment of the present invention.

FIG. 12 is a partial perspective view of the third embodiment showing the operation of the embodiment.

FIGS. 13 and 14 are schematic views about the operation of a prior art cutting device.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

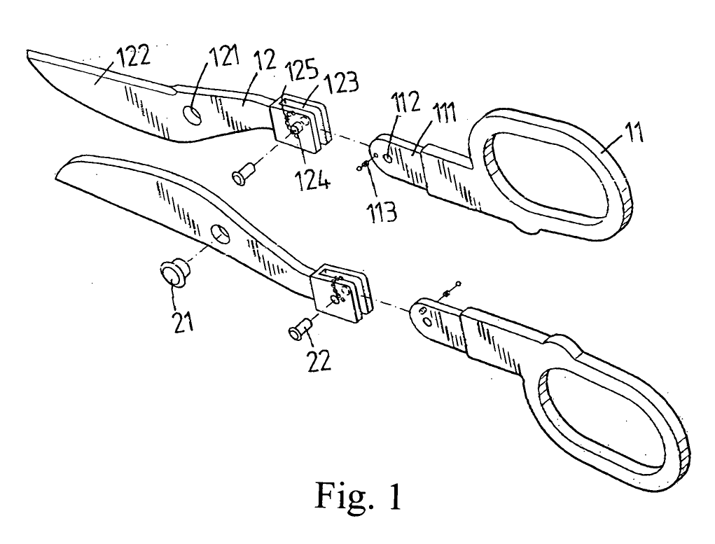

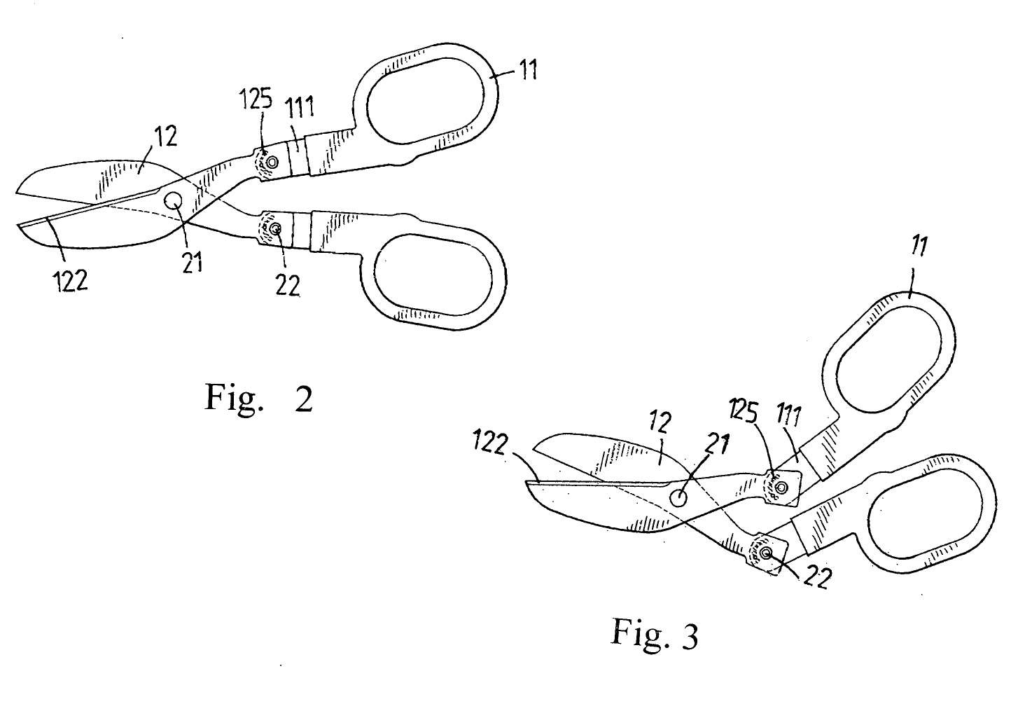

Referring to FIGS. 1 and 2, the bendable cutting device of the present invention is illustrated. The bendable cutting device has the following elements.

A pair of holding portions 11 are included. Each holding portion 11 is holdable by users to apply a force. A front end of each holding portion 11 has a pivotal block 111. Each holding portion 11 has a through hole 112 and a positioning unit 113. The positioning unit 113 is formed by a spring and a steel ball.

A pair of cutting portions 12. The cutting portions 12 are pivotally installed to the pair of holding portions 11. Each cutting portion 12 has a pivotal hole 121. A pivotal shaft 21 serves to pivotally and rotatably connect the two cutting portions 12. A front inner end of each cutting portion 12 has a knife portion 122. When the two cutting portions 12 are moved closer, the knife portions 122 serve to cut an object clamped between the two knife portions 122. A rear end of each cutting portion 12 has a pivotal recess 123. By the pivotal recess 123, the cutting portion 12 can be engaged to the pivotal block 111 of a respective holding portion 11. Each pivotal recess 123 has a via hole 124. By inserting the pivotal block 111 into a respective pivotal recess 123 and aligning the through hole 112 to the via hole 124 and then a retainer 22 passing through the through hole 112 and the via hole 124, the holding portions 11 are connected to the cutting portions 12. Each pivotal recess 123 is formed with a plurality of holes 125. By matching the holding portions 11 to the cutting portions 12, the positioning unit 113 of each holding portion 11 can be received in one of the holes 125 so as to fix the holding portion 11 to the cutting portion 12 with a predetermined angle.

In assembly of the present invention, the two pivotal holes 121 of the two cutting portions 12 are aligned and the pivotal shaft 21 passes through the two pivotal holes 121 so as to fix the two cutting portions 12. Then each pivotal block 111 is inserted into a respective pivotal recess 123. A retainer 22 serves to passes through the through hole 112 of the pivotal block 111 and the via hole 124 of the pivotal recess 123. Thus, each holding portion 11 is pivotally installed to a respective cutting portion 12. Furthermore, each positioning unit 113 is received into one of the holes 125 in the inner side of the pivotal recess 123. Thus the holding portion 11 can be adjusted to a predetermined angle without vibration. An assembly view of the present invention is illustrated in FIG. 2.

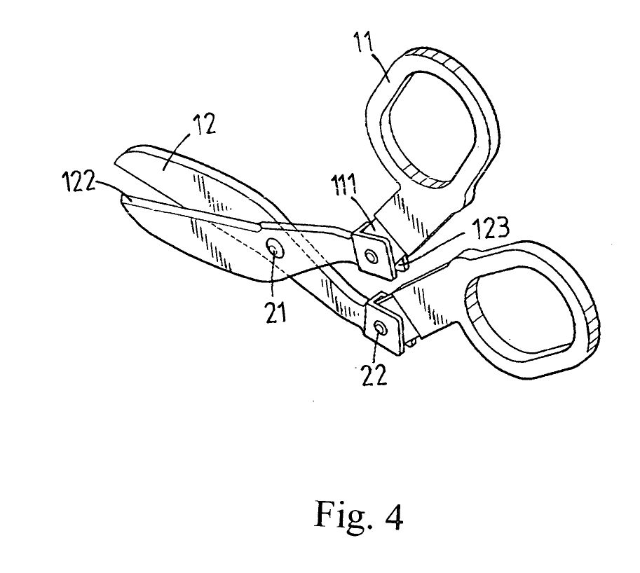

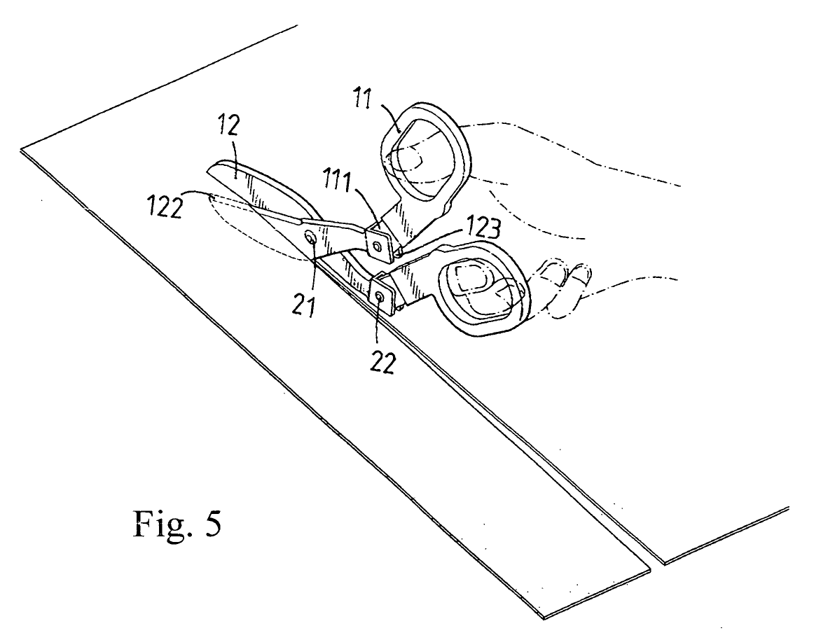

Referring to FIGS. 3 to 5, in use of the present invention, the angles between the holding portions 11 and the cutting portions 12 are adjusted so that the two holding portions 11 are bent to the same side (referring to FIG. 3). When cutting an object, the hand of the user can be placed at the same side (referring to FIG. 5) so as not be interfered by the object to be cut and the hand of the user will not be hurt. Thereby the cutting operation can be performed easily. Specifically, when a hard object is cut, to bend the holding portions 11 aside has a preferred effect, which can reduce the object to be as an obstacle in operation.

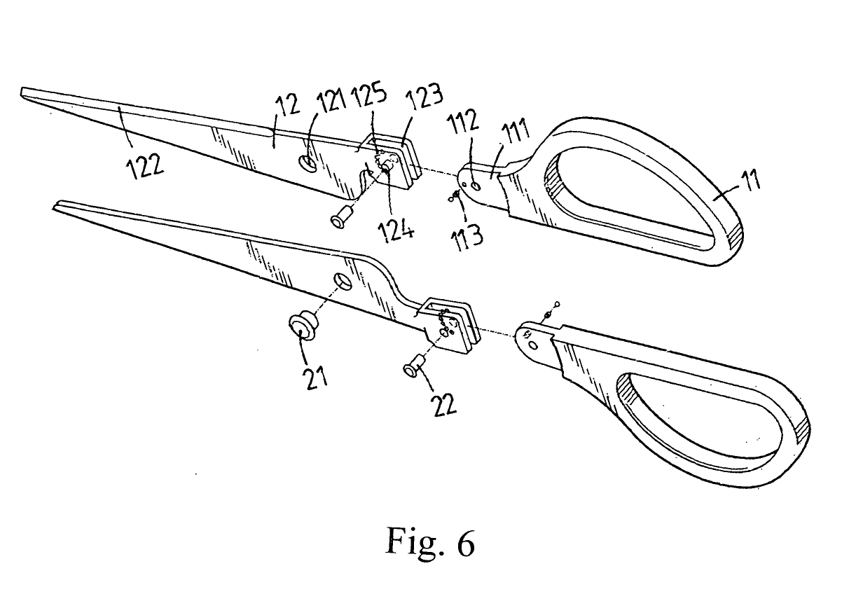

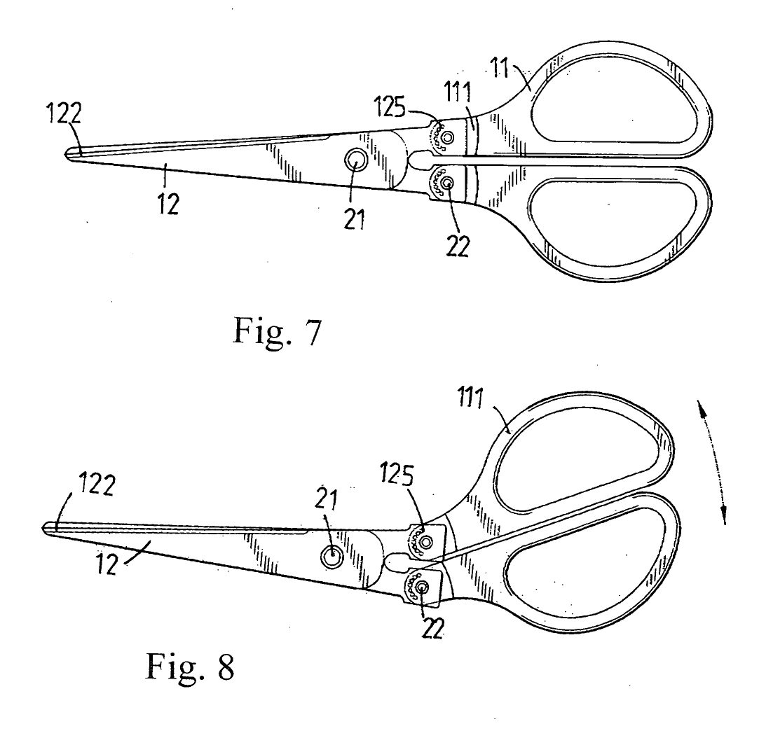

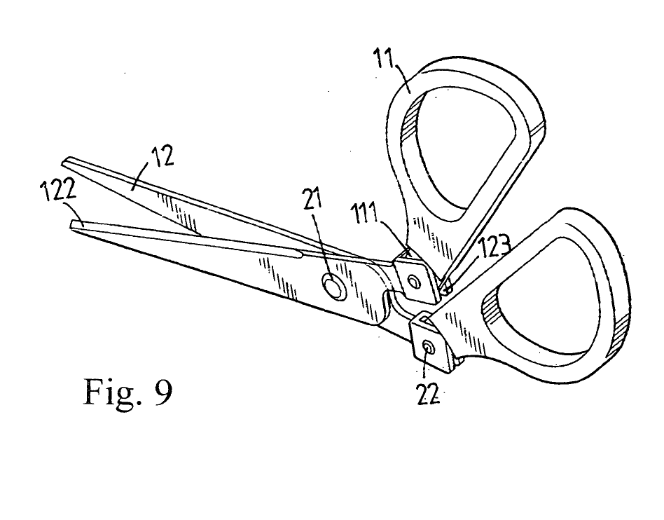

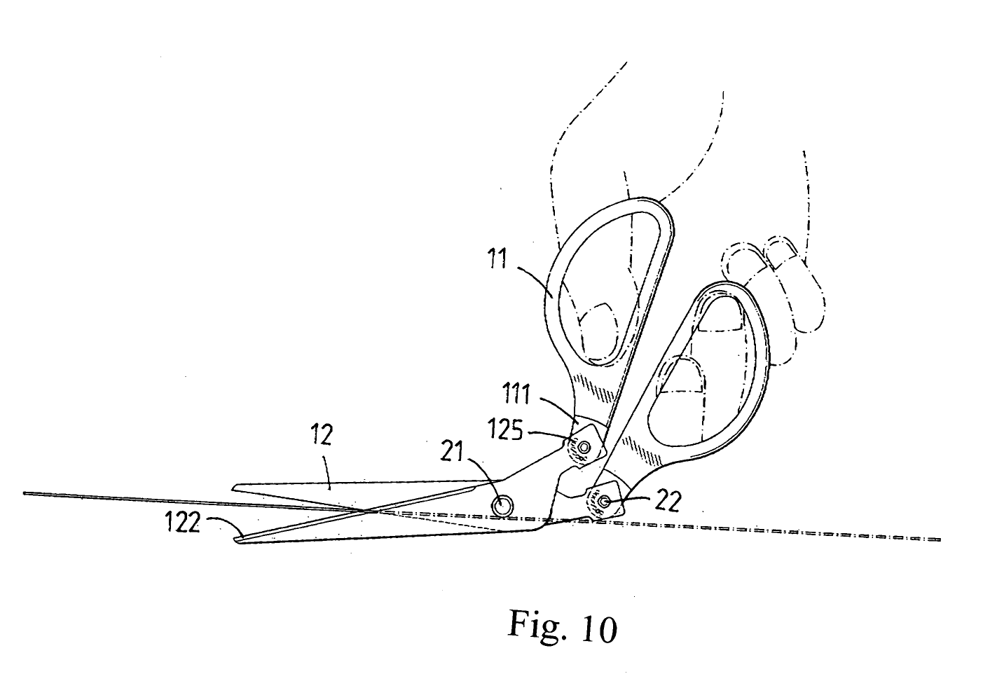

With reference to FIGS. 6 to 10, the second embodiment about the bendable cutting device of the present invention is illustrated. The same elements as above first embodiment will not be described herein. Only those different are described. To have a wide application in use of the present invention, the bendable cutting device is realized as a pair of general scissors. In that the holding portions 11 can be bent asides so as to make the cutting operation easy.

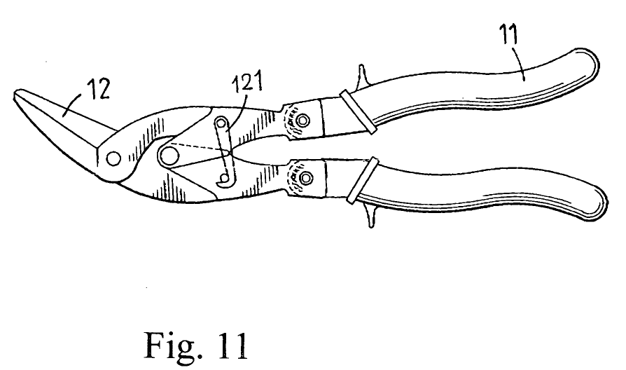

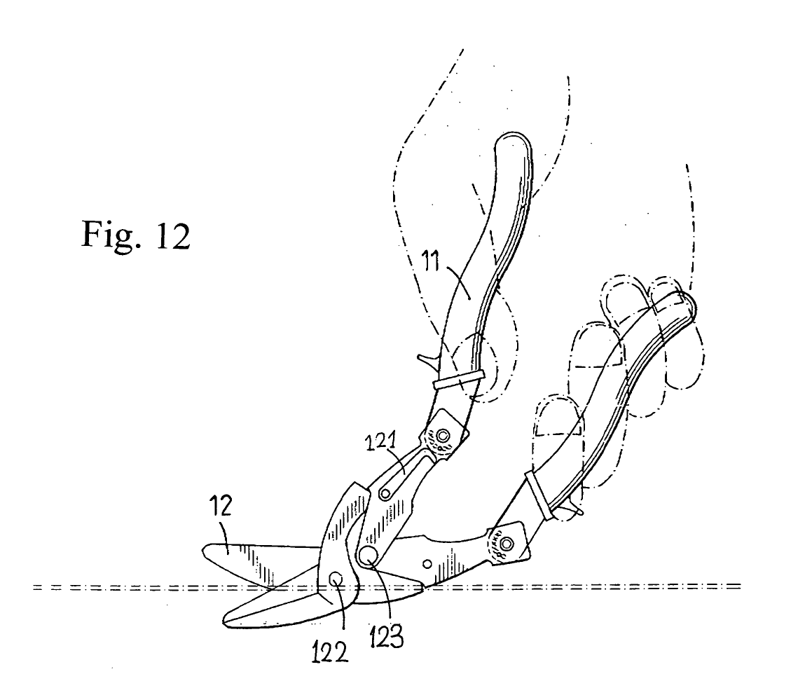

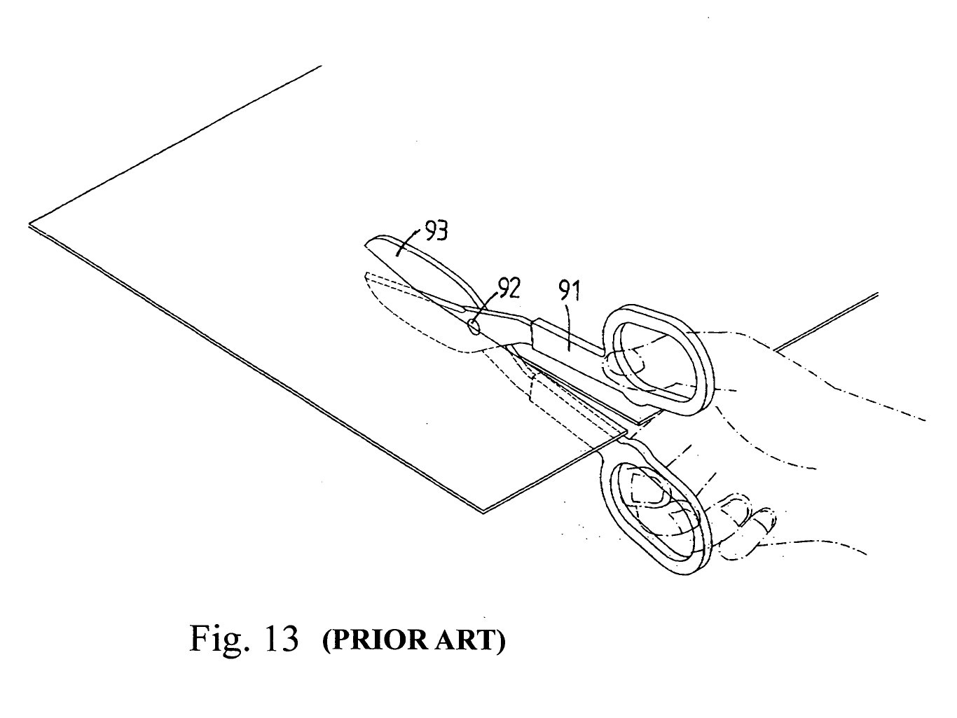

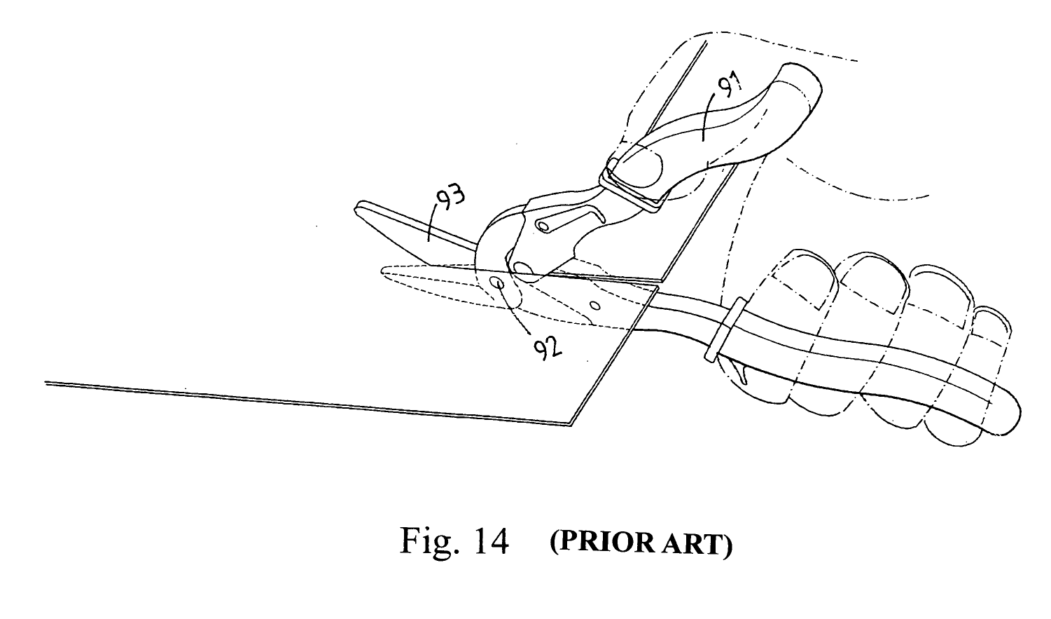

Referring to FIGS. 11 and 12, the third embodiment about the bendable cutting device of the present invention is illustrated. The same elements as above first embodiment will not be described herein. Only those different are described. To have a wide application in use of the present invention, the bendable cutting device is realized as a pair of iron cutting scissors. In that the holding portions 11 can be bent asides so as to make the cutting operation easy. In this the present invention, the cutting portions 12 are bended and one of the pair of cutting portions 12 is connected to another end of the pair of the cutting portions 12 at two pivotal portions 122, 123; and a latch 121 is used to fix the pair of cutting portions 12, one end of the latch 121 is pivotal installed to one of pair of the cutting portions 12 and another end is hookable to the other one of the pair of the cutting portions 12.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bendable cutting device comprising:
a pair of holding portions;
a pair of cutting portions; the two cutting portions being pivotally installed to one another; an inner side of each cutting portion having a knife portion; each cutting portion being pivotally installed to one end of a respective one of the holding portions; so that the holding portions being rotatable to the cutting portions to the same side, wherein by moving the two cutting portions closer, the two cutting portions serve to cut one object clamped between the two cutting portions;
wherein each cutting portion has a U shape unit having a pivotal recess therein and each holding portion has a pivotal block; a retainer serves to pivotally install the pivotal block into the pivotal recess so that the holding portion is assembled to the cutting portion;
wherein one inner side of the pivotal recess has at least one holes and the pivotal block has a positioning unit corresponding to the holes; the positioning unit is capable of being fixed into one of the hole so that the holding portion is fixed to the cutting portion;
wherein the positioning unit is formed by a spring and a steel ball;
wherein the cutting portions are bended and one of the pair of cutting portions is connected to another end of the pair of the cutting portions at two pivotal portions (122, 123); and
wherein a latch (121) is used to fix the pair of cutting portions, one end of the latch is pivotal installed to one of pair of the cutting portions and another end is hookable to the other one of the pair of the cutting portions.

2. The bendable cutting device as claimed in claim 1, wherein bendable cutting device is a pair of scissors.

3. bendable cutting device as claimed in claim 1, wherein the bendable cutting device is a pair of scissors for cutting iron sheets.

4. A bendable cutting device comprising:
a pair of holding portions;
a pair of cutting portions; the two cutting portions being pivotally installed to one another; an inner side of each cutting portion having a knife portion; each cutting portion being pivotally installed to one end of a respective one of the holding portions; so that the holding portions being rotatable to the cutting portions to the same side, wherein by moving the two cutting portions closer, the two cutting portions serve to cut one object clamped between the two cutting portions;
wherein each cutting portion has a U shape unit having a pivotal recess therein and each holding portion has a pivotal block; a retainer serves to pivotally install the pivotal block into the pivotal recess so that the holding portion is assembled to the cutting portion;
wherein one inner side of the pivotal recess has at least one holes and the pivotal block has a positioning unit corresponding to the holes; the positioning unit is capable of being fixed into one of the hole so that the holding portion is fixed to the cutting portion; and
wherein the positioning unit is formed by a spring and a steel ball.

5. The bendable cutting device as claimed in claim 4, wherein the cutting portion is bended.

6. The bendable cutting device as claimed in claim 5, wherein bendable cutting device is a pair of scissors.

7. The bendable cutting device as claimed in claim 6, wherein the bendable cutting device is a pair of scissors for cutting iron sheets.
